(19) United States
(12) Patent Application Publication
(10) Pub. No.: US 2026/0005937 A1
(43) Pub. Date: Jan. 1, 2026

(54) Cloud Based Logging Framework

(71) Applicant: Oracle International Corporation, Redwood Shores, CA (US)

(72) Inventors: Hemant BANSAL, Bangalore (IN); Saurav MONDAL, Bangalore (IN)

(21) Appl. No.: 18/760,100

(22) Filed: Jul. 1, 2024

(51) Int. Cl. H04L 43/065; H04L 43/10

(52) U.S. Cl. CPC H04L 43/065; H04L 43/10

(57) ABSTRACT

Embodiments generate a log message in response to receiving a log event corresponding to a client. Embodiments identify a log message template that corresponds to the log event, the log message template including an identifier and zero or more required parameters. Embodiments generate the log message including the identifier and the zero or more parameters. Embodiments then transmit the log message to a logging server.

### FIELD

One embodiment is directed generally to a computer system, and in particular to an application logging framework for a computer system.

### BACKGROUND INFORMATION

Computer applications include web sites, sales applications, media content, financial databases, customer records, inventory management applications, etc. A large cloud computing network may feature a large number of data centers around the globe that each have numerous computers implementing cloud based applications. The management of these large cloud and complex computing networks is a significant challenge. Computer analysts often study computer performance logs to manage cloud computing networks. The computers that comprise the cloud generate the computer performance logs as a part of their normal operation. The computer performance logs are human-readable statements that indicate the current status of the circuitry, operating systems, databases, and applications in the cloud.

A typical computer performance log, for example, might be “HOST X23 STARTS APP 341267 2108:06:03:14:33:18.” In large cloud computing networks, a massive number of computers may each produce performance logs every second or so. This raw amount of computer performance logs is a challenge to digest. In addition, the diversity of computer performance logs is also a challenge because the logs are not uniform. The syntax of computer performance logs may not only differ between individual computers but may change over time as well.

Data network operators use computer performance logs to service the end-users of the cloud computing networks. For example, a computer technician may receive an alarm that a hospital is experiencing excessive database latency. The computer technician may study the relevant computer performance logs for the computers that serve the hospital to solve the latency problem. The computer technician may then establish an automated computer response to specific computer performance logs by subsequently detecting the same log text and launching a pre-selected computer script. This manual approach to processing computer performance logs is not scalable.

Computer technicians cannot manually handle the massive amount of computer performance logs, so automated computer tools have been developed. These log analytic tools require structured log lines that are pre-associated with known anomalies, but this not proven to be an effective situation in many global computer networks. Many log analytic tools operate off-line on archived log lines to detect performance anomalies, but the off-line log analytic tools are too slow to mitigate computer performance anomalies in real-time. Current log analytic tools are not optimized to handle the massive quantity of diverse computer performance logs that are produced by today's global computer networks. Current log analytic tools are not configured to efficiently detect and mitigate these complex computer performance anomalies in real time.

Server administrators and application administrators can benefit by learning about and analyzing the contents of the system log records. However, it can be a very challenging task to collect and analyze these records. There are many reasons for these challenges, including the potentially large volume of records and the corresponding large needed processing time.

One significant issue pertains to the fact that many modern organizations possess a very large number of computing systems, each having numerous applications that run on those computing systems. It can be very difficult in a large system to configure, collect, and analyze log records given the large number of disparate systems and applications that run on those computing devices. Further, some of those applications may actually run on and across multiple computing systems, making the task of coordinating log configuration and collection even more problematic.

Conventional log analytics tools provide rudimentary abilities to collect and analyze log records. However, conventional systems cannot efficiently scale when posed with the problem of massive systems involving large numbers of computing systems having large numbers of applications running on those systems. This is because conventional systems often work on a per-host basis, where set-up and configuration activities need to be performed each and every time a new host is added or newly configured in the system, or even where new log collection/configuration activities need to be performed for existing hosts. This approach is highly inefficient given the extensive number of hosts that exist in modern systems. Further, the conventional approaches, particularly on-premise solutions, also fail to adequately permit sharing of resources and analysis components. This causes significant and excessive amounts of redundant processing and resource usage.

Event processing/logging is a need of every running computer system and software application. When executing on the cloud, the logs are generally streamed to a logging server. However, these cloud based logging servers typically can be overwhelmed by number of streams and volume to be processed in order to make the logs useful. For example, to make the logs searchable, the logging server needs to process each string of the log, which is complex and compute heavy.

### SUMMARY

Embodiments generate a log message in response to receiving a log event corresponding to a client. Embodiments identify a log message template that corresponds to the log event, the log message template including an identifier and zero or more required parameters. Embodiments generate the log message including the identifier and the zero or more parameters. Embodiments then transmit the log message to a logging server.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Further, elements may not be drawn to scale.

FIG. 1 illustrates an example of a system that includes a template based logging system in accordance to embodiments.

FIG. 2 is a block diagram of a computer server/system in accordance with an embodiment of the present invention that can be used to implement any of the functionality disclosed herein.

FIG. 3 is a block diagram of a logging client and logging server template based framework in accordance to embodiments.

FIG. 4 is a flow diagram of the functionality of the template based logging system of FIG. 1 and a logging client application when providing template based logging in accordance to embodiments.

FIG. 5 is a flow diagram of the functionality of the template based logging system of FIG. 1 when providing template based log retrieval in accordance to embodiments.

FIGS. 6-9 illustrate an example cloud infrastructure that can implement a cloud infrastructure that can include template based logging system of FIG. 1 in accordance to embodiments.

### DETAILED DESCRIPTION

Embodiments are directed to a template based logging system in which clients sent to a cloud based logging server, for each log, a template ID with optional parameters instead of an entire logging message string for event processing. Therefore, the amount of processing for each logging message is substantially reduced.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

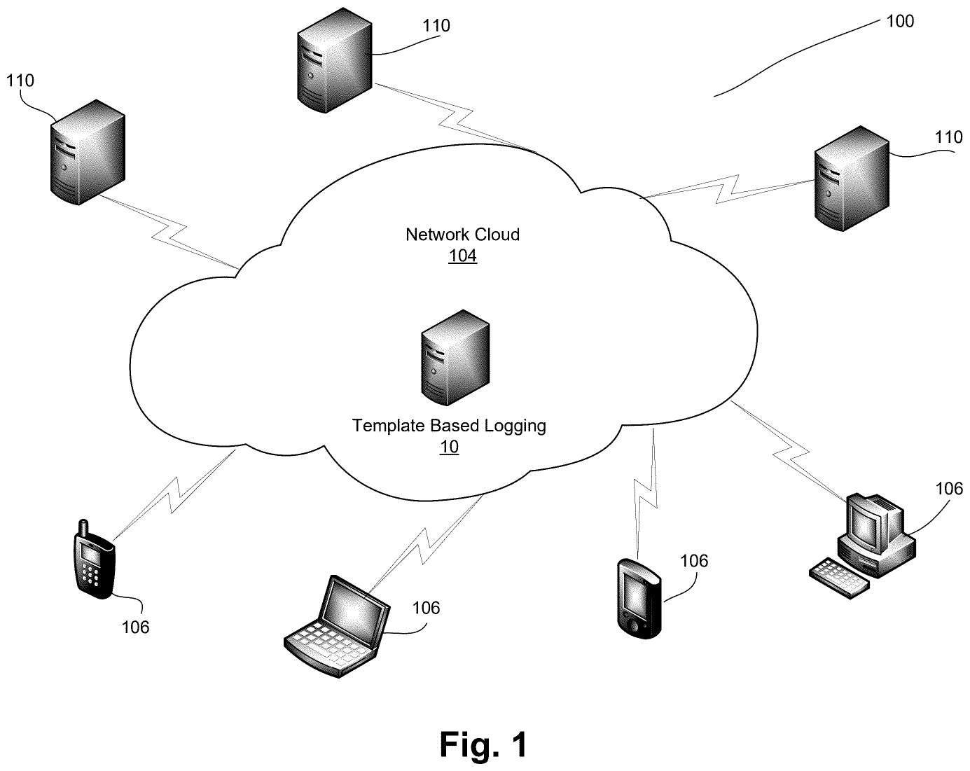

FIG. 1 illustrates an example of a system 100 that includes a template based logging system 10 in accordance to embodiments. Template based logging system 10 may be implemented within a computing environment that includes a communication network/cloud 104. Network 104 may be a private network that can communicate with a public network (e.g., the Internet) to access additional services 110 (i.e., cloud based applications) provided by a cloud services provider (i.e., a cloud infrastructure). Examples of communication networks include a mobile network, a wireless network, a cellular network, a local area network (“LAN”), a wide area network (“WAN”), other wireless communication networks, or combinations of these and other networks. Template based logging system 10 may be administered by a service provider, such as via the Oracle Cloud Infrastructure (“OCI”) from Oracle Corp.

Tenants of the cloud services provider can be organizations or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 106, which can be any type of device that can access network 104 and can obtain the benefits of the functionality of template based logging system 10 of providing logging for both cloud based and on-premise applications and generally functioning as a centralized logging server. Each client can be executed remote from cloud 104 or executed on cloud 104. As disclosed herein, a “client” (also disclosed as a “client system” or a “client device”) may be a device or an application executing on a device. System 100 includes a number of different types of client devices 106 that each is able to communicate with network 104.

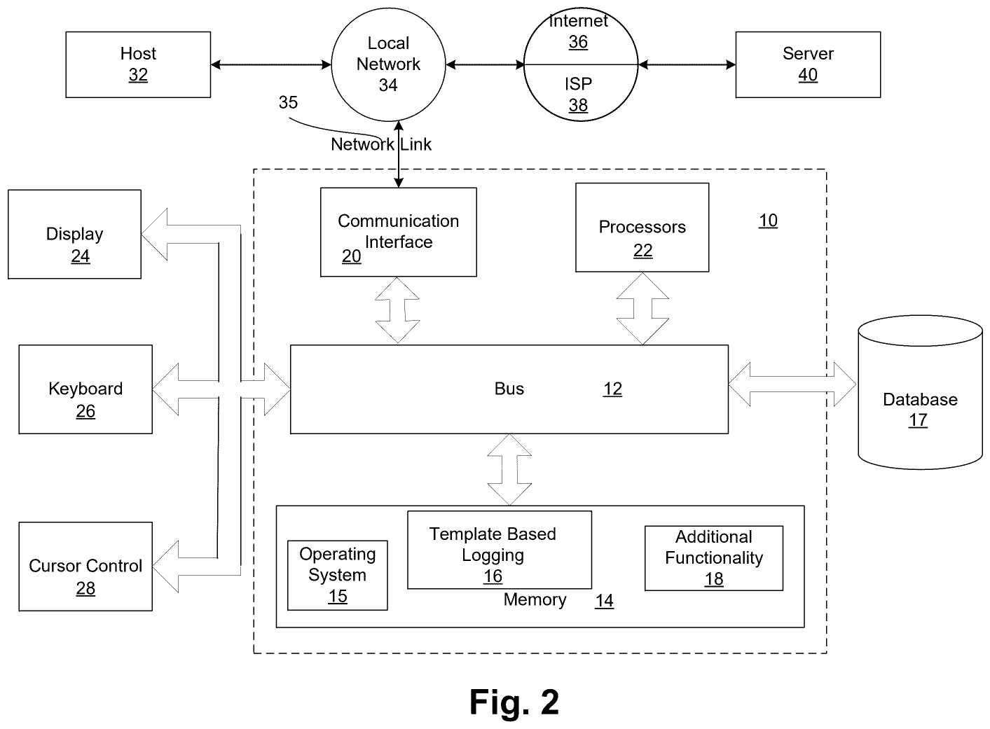

FIG. 2 is a block diagram of a computer server/system 10 in accordance with an embodiment of the present invention that can be used to implement any of the functionality disclosed herein. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a template based logging module 16 that provides logging for both cloud based and on-premise applications, including functioning as a centralized logging server, and all other functionality disclosed herein. System 10 can be part of a larger system. Therefore, system 10 can include one or more additional functional modules 18 to include the additional functionality used with a logging server. A file storage device or database 17 is coupled to bus 12 to provide centralized storage for modules 16 and 18, including mapped template IDs and analytic data. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 800, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

As disclosed, logging or event processing is a need of every executing application program and computer system, whether on-premise or remotely via, for example, a cloud implementation. When applications are executing on a cloud, such as cloud 104, the logs are generally streamed to a logging server. However, logging servers can be overwhelmed by the number of streams and volume to be processed. For example, to make the received logs searchable, a logging server needs to process a text string corresponding to each log, which is complex and compute heavy.

For example, generally, known logging servers accept simple logging statements as a series of words. Even repetitive statements are stored in a repetitive manner. For example, if an application logs a message such as “Object is not yet available. Trying after 5 sec . . . ”, 10 different times then the complete log message will travel over the network 10 times, and the logging server will store the same message 10 times and processes it 10 times by tokenizing each word of the string.

In contrast, embodiments are directed to a logging server and template based logging that minimizes storage space and processing time for processing logs compared to known logging server solutions. In embodiments, every log statement is template based. A template-based logging statement can include zero or more parameters. A corresponding template ID is generated upon registering each template at both the client and the logging server. Logging clients need to send only the template ID and parameters to the logging server, instead of sending an entire log message.

For example, in order to process a log message of “Resource object is successfully created with ID 123456”, embodiments will first create and register a template with a single parameter such as “Resource object is successfully created with id <<id>>” and a corresponding identifier (“ID” or “id”) that identifies the template. When log events with this message are generated at a client, the client merely sends the template <id>> and parameter to the logging server instead of the entire string.

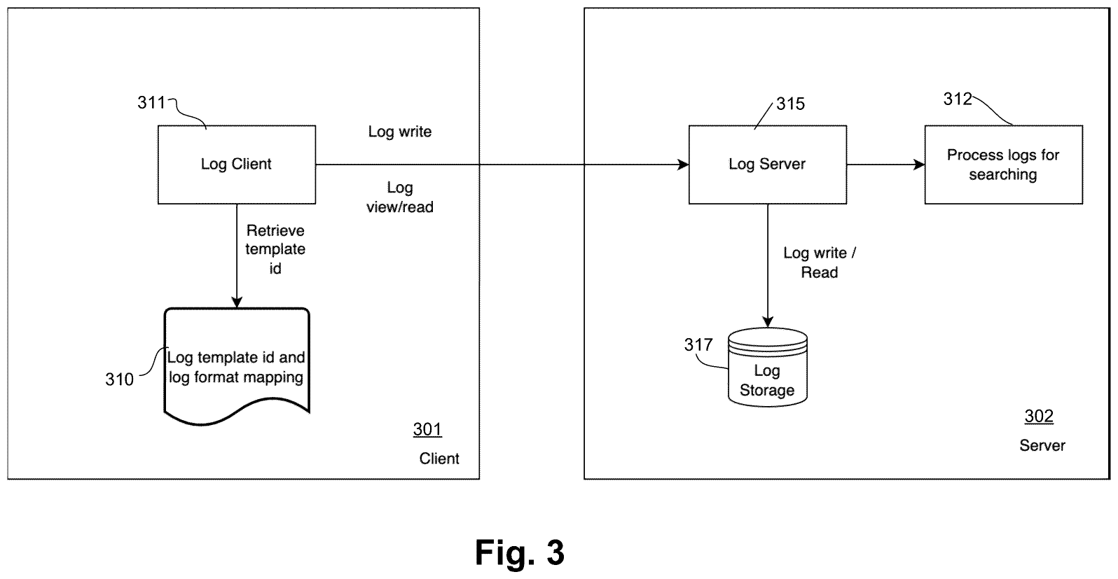

FIG. 3 is a block diagram of a logging client and logging server template based framework in accordance to embodiments. A client 301 executes an application that generates logs. Client 301 can be an on-premise or cloud based computer system. Client 301 includes a log client 311 that stores at 310 a list of log template IDs and corresponding log format mapping, including whether any parameters need to be included with each log template. In response to a logging issue, log client 311 retrieves the template ID, inserts parameters if needed, and uploads it to server 302 (e.g., template based logging server 10 of FIG. 1). Log client 311 functions as a log transmitter and log viewer/reader.

Server 302, at log server 315, receives the log message, in the form of template ID and any required parameters, and saves it on log storage 317, as well as forwarding it to 312 for processing needed for log search and analytics. The processing optionally includes tokenizing the log text to make it searchable for a presentation layer. The presentation layer (not shown) generally allows for the searching of logs based on user input and displaying search results as plain text or graphics. Server 302 also can store the log template IDs and corresponding log format mapping, including whether any parameters need to be included with each log template.

In embodiments, server 302 is a OCI cloud based logging server that enables the managing and searching of logs that are generated by cloud based and on-premise applications. The different types of logs include audit logs, which are logs related to events emitted by a cloud infrastructure audit service. Further, the types of logs include service logs that are emitted by OCI native services, such as API Gateway, Events, Functions, Load Balancer, Object Storage, and VCN Flow Logs. Each of these supported services has predefined logging categories that can be enabled or disabled. The types of logs further include custom logs that contain diagnostic information from custom applications, other cloud providers, or an on-premises environment. Custom logs can be ingested through the API, or by configuring a Unified Monitoring Agent.

Examples of log templates used in embodiments without parameters are as follows:
Successfully started the application
Successfully uploaded pending files
Failed to finish operation
Failed to start server
Your cloud tenant has reached its total virtual machine (“vm”) quota limit. Contact your Administrator to increase the limits
Invalid query. Please refer documentation for supported filters and sortBy parameters
VM does not have enough resources to start new pod. You can either create new vm with higher configuration or wait for active pods to be terminated

Examples of log templates used in embodiments with one parameter are as follows, where the parameters are shown as {<parameter>}:
Received request to create an application: {<text-body-of-request>}
Metastore cannot be found with id {<metastoreId>}
Failed to find or create group for namespace {<name>}
Successfully created application {<appId>}
Service is experiencing capacity limitation for {<vmType>} vm shape.
   Please retry in a few minutes, or use a different shape. Please submit a support ticket if you need a limit increase for any shape

Examples of log templates used in embodiments with multiple parameters are as follows:
{<Name-of-participant>} joined meeting as {<co-host/host/member/guest>}
Failed to retrieve database {<dbId>} associated with application {<appId>} in namespace {<namespaceId>}
Identified the case where the object {<objectName>} stored in bucket {<bucketName>} is deleted already but the entry in cache is not refreshed yet
Your request exceeded configured timeout specified in {<config-name>} to start operation {<operationId>}. You can either increase the configured timeout or retry after sometime

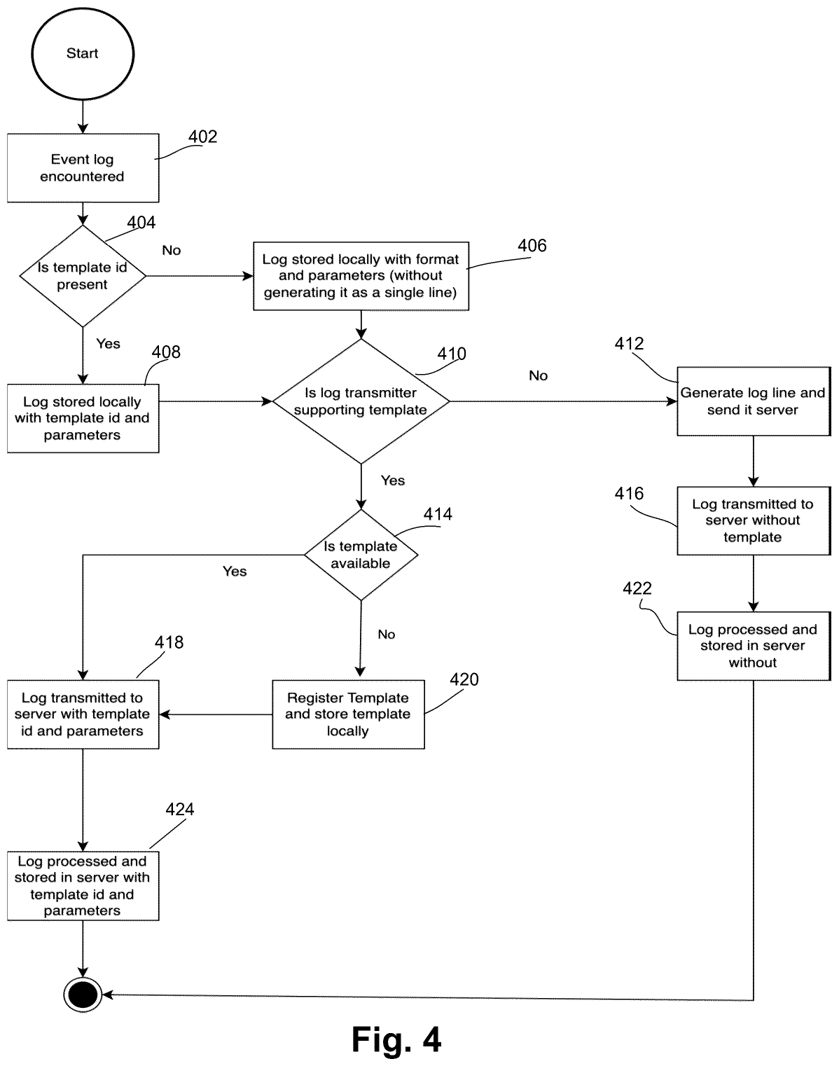

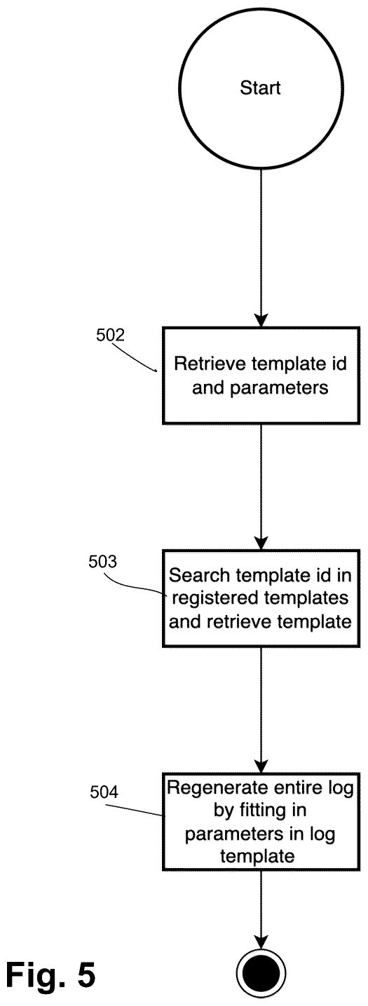

FIG. 4 is a flow diagram of the functionality of template based logging system 10 of FIG. 1 and a logging client application when providing template based logging in accordance to embodiments. In one embodiment, the functionality of the flow diagram of FIG. 4 (and FIG. 5 below) is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

The functionality of FIG. 4 further illustrates the log write flow, where the log template can be supported in three ways:
1. Static/Pre-registered: The template id is known to the developer/application and the template is registered upfront.
2. Dynamically Registered: The log template is not registered upfront. During log transmission by the application, the template can be created and registered dynamically by the log transmitter (i.e., log client 311 of FIG. 3) or other intermediator.
3. Template not supported: If the log template is not supported, then the log is transmitted in the traditional way (i.e., as a full string). For example, known systems that do not incorporate template based logging disclosed herein.

At 402, the event log is encounter by the application at client 301 by log client 311.

At 404, it is determined if a template ID the corresponds to the event log is present (i.e., stored at the client). This would be when the static/preregistered log template is supported, and can be include having the log instruction/command itself passes the template ID and can be implemented using a new API or a flag in existing APIs. If no at 404, at 406 the log is stored locally, by the corresponding application/client that generated the log, with the format and parameters, without generating it as a single line.

If yes at 406, at 408 the log is stored locally in the form of a template ID and parameters. At 410, it is determined if the log transmitter, which is part of the logging application/client, is supporting the template. If no at 412, the log line is generated and transmitted without a template (i.e., text string without a template ID), at 416 the log is transmitted to server 10, and at 422 the log is processed and stored in server without a template.

If yes at 410, at 414 it is determined if the template is available. If yes at 414, then at 418 the log is transmitted to server 10 in the form of a template ID and any required parameters. At 424, the log is processed (i.e., tokenized) and stored in server 10 with the template ID and parameters. This processing is faster than tokenizing an entire log line, as the template is already tokenized.

If no at 414, then at 420 the template is registered and stored locally at the application/client after being created by the client/application.

In general, for the functionality of FIG. 4, when an application encounters a log statement, the log client 311 takes charge. Before generating the log message, it checks if the template is present. If the template is present, then the log is stored locally (referred to as “write locally”) with template ID and parameters instead of resolving the template using parameters to generate the log message, and the template ID and parameters are then transmitted.

The functionality of writing the log locally is described in the following pseudocode:
1. Application encounters log statement to be written
2. Logger takes charge and checks if template id present
   a. if template id present then store locally with template id and parameter
   b. else log is stored locally with template (id not present) and parameter

The functionality of transmitting the log is described in the following pseudocode:
1. Log transmitter is invoked to transport log to server
2. Transmitter checks if template is supported
a. if template is supported, then
   i. if template id NOT present in log message and not available with the transmitter, then Register template dynamically and get a template id
   ii. Log is transmitted in template id and parameters form, instead of resolving entire log message using template and parameters
b. else
   i. Transmitter generates the log line by resolving template and parameters
3. Log is sent to the server.

FIG. 5 is a flow diagram of the functionality of template based logging system 10 of FIG. 1 when providing template based log retrieval in accordance to embodiments.

At 502, in response to a retrieval request, the template id and parameters is retrieved from either storage at the client or at logging server 10, depending on whether the client already has the template or not.

At 503, the template id is searched among the registered templates and the template is retrieved.

At 504, the entire log is regenerated by fitting in the parameters within the log template.

### Microservices Implementation

In embodiments, cloud 104 is implemented with microservices. A microservice is a software development technique where an application is structured as a collection of loosely coupled services. Each service is designed to perform a specific business function and can run independently of other services. These services communicate with each other typically through lightweight mechanisms such as HTTP/REST or messaging queues.

The key characteristics of microservices include: (1) loose coupling: each service is independent and can be developed, deployed, and scaled independently of others. Changes to one service do not require changes to others; (2) single responsibility: each service focuses on a specific business capability or function, following the Single Responsibility Principle; (3) independent deployment: microservices can be deployed independently, allowing for more frequent updates and releases; (4) technology diversity: different services within an application can be implemented using different technologies, suited best for the specific task at hand; (5) scalability: services can be scaled independently based on demand, allowing for better resource utilization; and (6) resilience: failure in one service should not bring down the entire system. Services are designed to be resilient, with mechanisms such as redundancy and failover.

Typically a microservice is deployed as an independent instance and it comes with a log agent that functions as log client 311 in embodiments. In embodiments, there can many microservices and log agents, but a single log server will store all of the templates. If the template IDs are not static, individual microservices need not to store those locally. Templates can be handled by the log agent as shown in the above flow chart. The microservices with log agent can be implemented on-premise or on the cloud.

When the template IDs are static, it is ideal for the microservice, as it does not need to keep the templates in the source code itself (i.e., the text (format) need not to be present at the client/application, as only the template ID is needed). For dynamic template IDs, there may be two implementations:

### 1. Log Agent is Implicit in Microservice

The template itself is already part of the code section of the microservice. The extra requirement is to get the template ID if not known and maintain the mapping of the template ID and template reference.

### 2. Log Agent is a Sidecar

Here agent is a separate process, and it is up to the agent how it manages the template mapping. For example it can maintain a cache or local lightweight storage for most frequently used templates. Otherwise it can fetch from the server periodically or on-demand.

The microservice provides the added advantage to manage logging within its own scope, limiting the number of templates since only those logs generated by an individual microservice need corresponding templates.

As disclosed, using templates for logs as with embodiments provides advantages over traditional logging approach in various ways, including data read, write, transfer, processing and analytics. Specifically, for data write, when a log is written in storage the entire log message is not written. Only the log template ID and parameters are written. Whether it be local file or server storage, less space is consumed.

In one example, the storage consumption for templated log is more than a 3× improvement compared to “normal” logs. The sample normal log is taken as “Your request exceeded configured timeout specified in request to start operation CreatePool. You can either increase the configured timeout 30 m or retry after sometime” which comprises of 168 character length. When it is stored in templated format, the template is stored as “Your request exceeded configured timeout specified in % s to start operation % s. You can either increase the configured timeout % s or retry after sometime”. The parameters stored as “request,CreatePool,30 m” which comprises of 22 character length and 2 for storing the reference of template. If apart from the message or parameters storage the metadata of log takes 50 characters each time, and when in range of 50 k logs are stored, the template takes constant space. Each templated log takes 22+2+50=74 and each normal log takes 168+50=218. So, the templated log is 218/74=2.945945˜˜3× better in terms of space complexity.

Further, as a less amount of data is written and stored with embodiments, the data write is faster as it requires lower disk input/output. As the log writing process does not need to generate an entire log string, the log processing time during the write is also faster.

For data transfer, as only the template ID and parameters are transferred over the network in a distributed environment (i.e., the cloud), the in-flight data amount is also less. This saves network bandwidth and data transfer is also faster.

For data processing, most logging servers have a search capability. A search enabled log server needs to do indexing upon receiving logs. With embodiments, since the log is sent in template form, which can be pre-indexed, indexing is minimal, which saves data processing cost.

For data read, while searching for log with a substring or part of the log, the read time is faster. As the logs are in template format, the size of entries in log storage are less compared traditional approaches. Therefore, when a substring is searched in the entire log storage, to retrieve a log message from storage, the retrieval process involves only the templates and not all log entries. For example, assume there are 100 templates in a system, each having 10 entries in storage, totaling 1 k entries in log storage. If a substring is searched using known approaches, it is searched over the 1 k entries. However, with embodiments, the searching is only among 100 entries of templates. If the read requester supports template IDs, then the server can just send the templates, template IDs and parameters. It saves overall data transmission for read as well.

In connection with machine learning (“ML”) analytics, if analytics are involved on the logging, then token generation on the text is faster as the count of templates is less compared to log entries. Based on predefined templates, the tokens can be generated upfront. It helps in reducing overall turn-around time for token generation. Also the templates provide optimization opportunity for ML algorithms as the order of words in templates is known. Instead of running an algorithm on set of unknown entries of log, it runs on a set of known log templates.

### Example Cloud Infrastructure

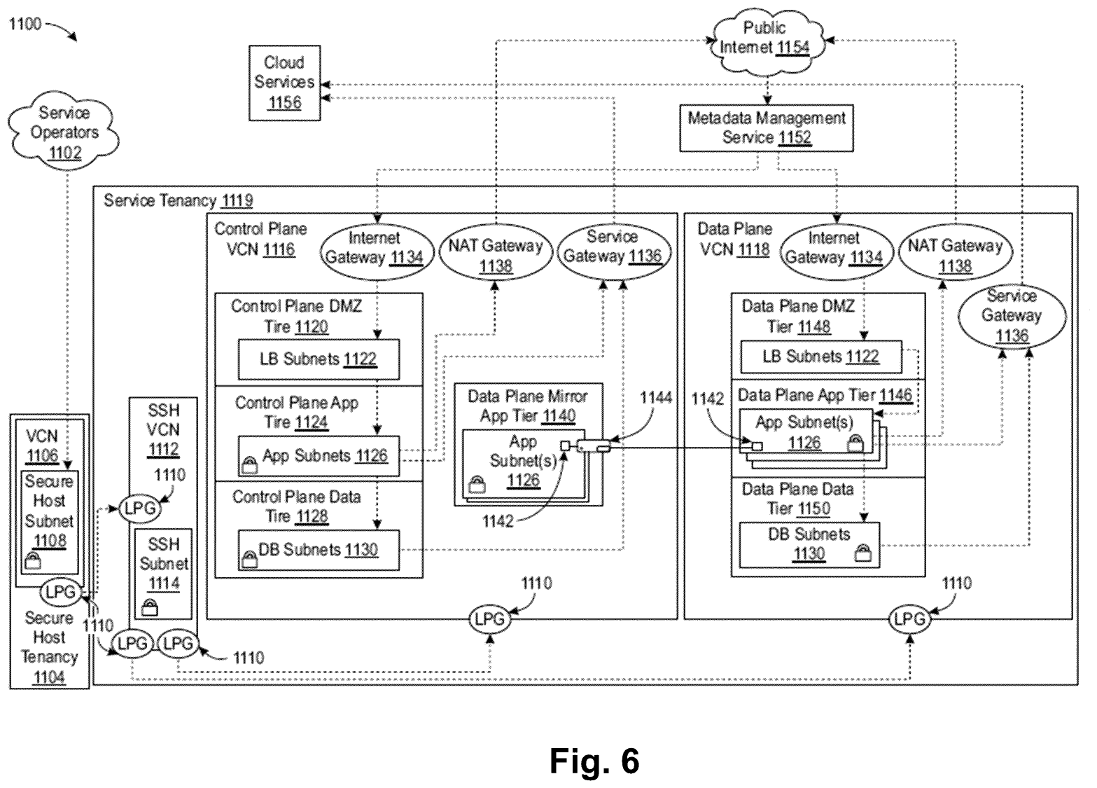

FIGS. 6-9 illustrate an example cloud infrastructure that can implement cloud 104 that can include template based logging system 10 and clients 106 of FIG. 1 in accordance to embodiments.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like. In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS”s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Meta Quest® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

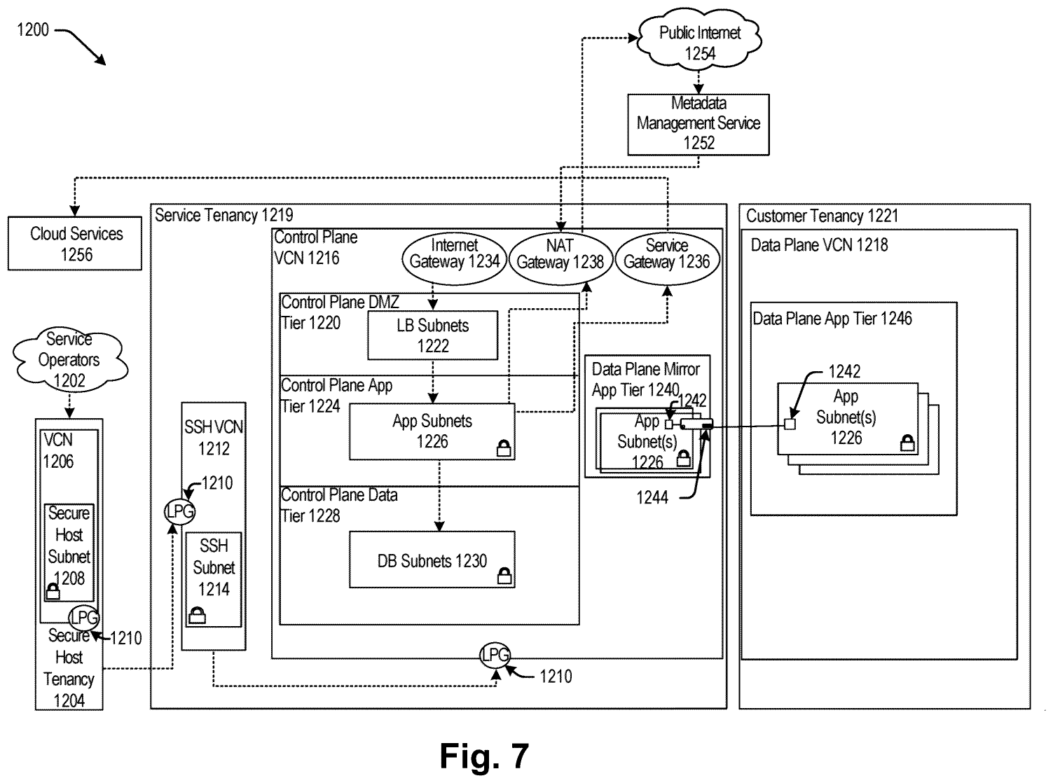

FIG. 7 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

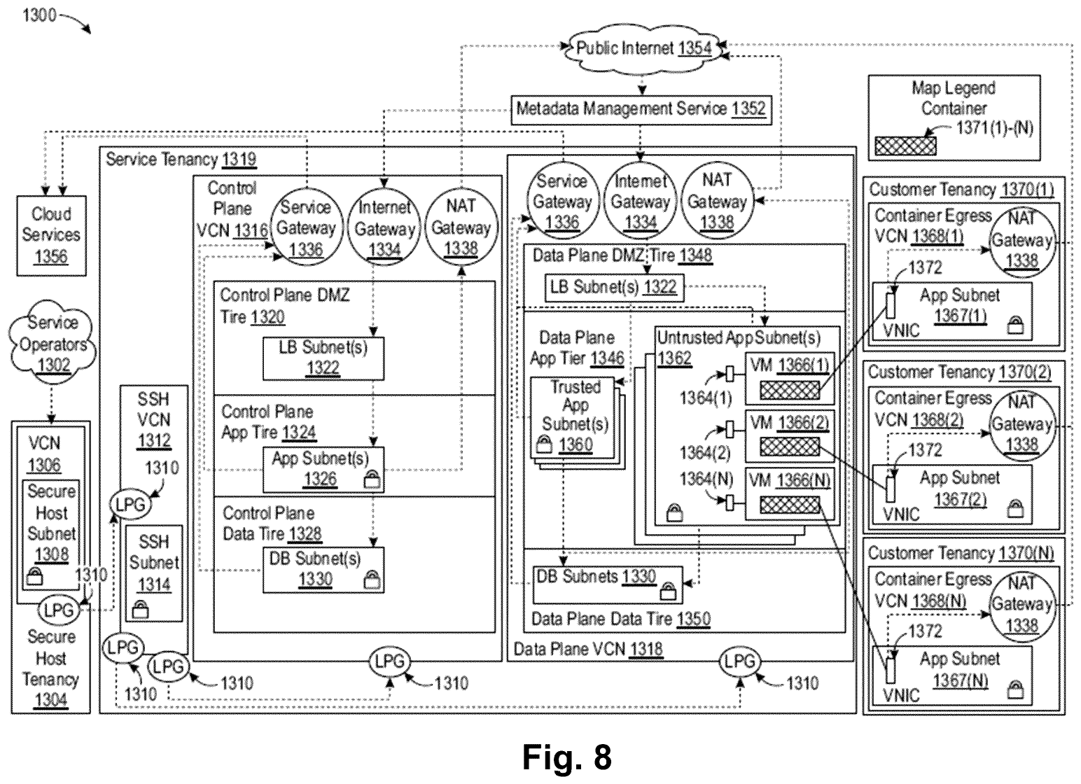

FIG. 8 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150 of FIG. 12). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

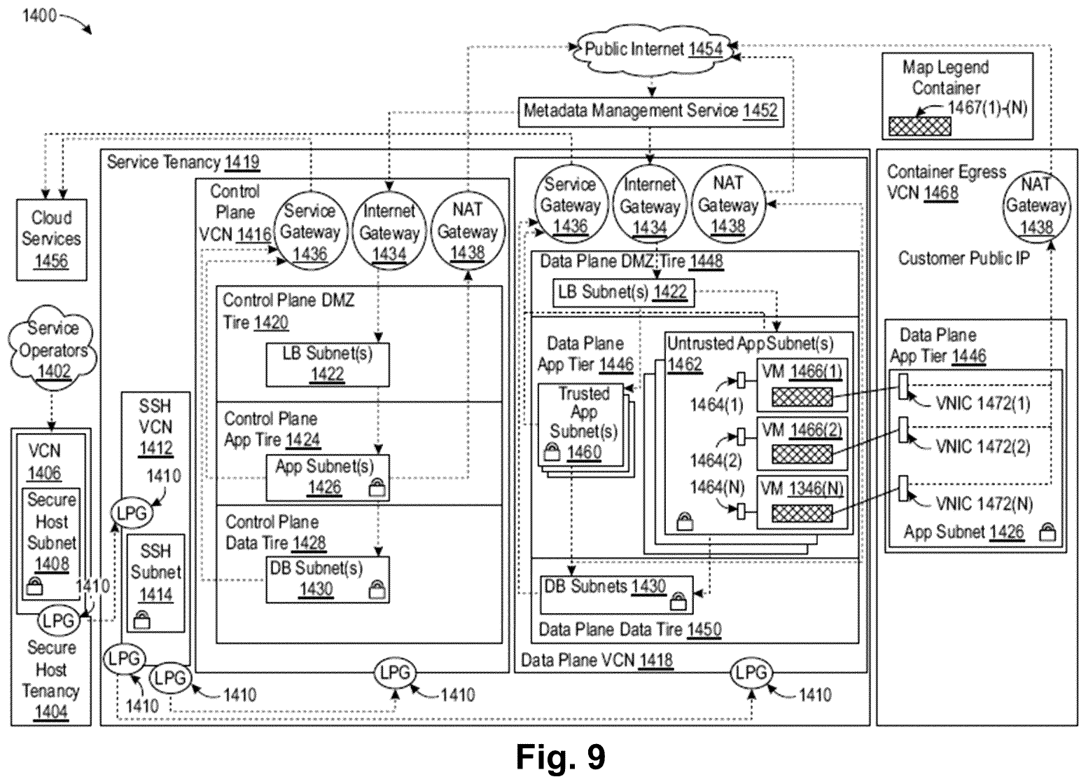

FIG. 9 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway 1136) and a network address translation (NAT) gateway 1438 (e.g. the NAT gateway 1138). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 9 may be considered an exception to the pattern illustrated by the architecture of block diagram 1300 of FIG. 8 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments provide a logging framework in which, for logging events, instead of a log string, only a template ID and optional parameters need to be generated and transmitted to the logging server. As a result, the log event generator software does not need not process a string to generate the log message. Further, when the log event is streamed to the log server, only the template ID and the value of parameter {<id>} needs to travel over network. Further, the log processing engine can have pre-tokenized templates and just needs to know values of parameters to process message, significantly improving processing time. Further, for event message storage, only the ID and parameter values need to be stored.

In contrast with known logging systems that send logs as is from the client system, in embodiments the log generating software need not to process string for generation of each log message. Embodiments reduce the number of words in the log message by many folds and it reduces storage space for the log server. Embodiments require much less network bandwidth for sending message to the log server in a distributed environment. Embodiments can reduce the complexity of an internal logging system and reduce the retrieving and processing time of the logs.

Generally, known approaches to log reduction focus on the compression of log messages by using text compression algorithms. In contrast, embodiments reduce the text requirement itself for each log message.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of generating a log message, the method comprising:
receiving a log event corresponding to a client;
identifying a log message template that corresponds to the log event, the log message template comprising an identifier and zero or more required parameters;
generating the log message comprising the identifier and the zero or more parameters; and
transmitting the log message to a logging server.

2. The method of claim 1, the transmitted log message consisting of the identifier and the zero or more required parameters.

3. The method of claim 1, further comprising:
in response to receiving the log event, dynamically creating and registering the log message template when the log message template was not previously registered.

4. The method of claim 1, further comprising:
in response to a request to retrieve log messages, regenerating each log message by retrieving stored log templates and fitting parameters within each retrieved log templates.

5. The method of claim 1, wherein the client comprises a microservice comprising an agent.

6. The method of claim 1, wherein the client and the server are implemented within a cloud infrastructure.

7. The method of claim 1, wherein the log event comprises one of an audit log or a service log.

8. A computer readable medium having instructions stored thereon that, when executed by one or more processors, cause the processors to generate a log message, the generating the log message comprising:
receiving a log event corresponding to a client;
identifying a log message template that corresponds to the log event, the log message template comprising an identifier and zero or more required parameters;
generating the log message comprising the identifier and the zero or more parameters; and
transmitting the log message to a logging server.

9. The computer readable medium of claim 8, the transmitted log message consisting of the identifier and the zero or more required parameters.

10. The computer readable medium of claim 8, the generating the log message further comprising:
in response to receiving the log event, dynamically creating and registering the log message template when the log message template was not previously registered.

11. The computer readable medium of claim 8, the generating the log message further comprising:
in response to a request to retrieve log messages, regenerating each log message by retrieving stored log templates and fitting parameters within each retrieved log templates.

12. The computer readable medium of claim 8, wherein the client comprises a microservice comprising an agent.

13. The computer readable medium of claim 8, wherein the client and the server are implemented within a cloud infrastructure.

14. The computer readable medium of claim 8, wherein the log event comprises one of an audit log or a service log.

15. A cloud based logging framework comprising:
one or more processors configured to:
receive a log event corresponding to a client;
identify a log message template that corresponds to the log event, the log message template comprising an identifier and zero or more required parameters;
generate the log message comprising the identifier and the zero or more parameters; and
transmit the log message to a logging server.

16. The cloud based logging framework of claim 15, the transmitted log message consisting of the identifier and the zero or more required parameters.

17. The cloud based logging framework of claim 15, the processors further configured to:
in response to receiving the log event, dynamically create and registering the log message template when the log message template was not previously registered.

18. The cloud based logging framework of claim 15, the logging server configured to:
in response to a request to retrieve log messages, regenerate each log message by retrieving stored log templates and fit parameters within each retrieved log templates.

19. The cloud based logging framework of claim 15, wherein the client comprises a microservice comprising an agent.

20. The cloud based logging framework of claim 15, wherein the log event comprises one of an audit log or a service log.
